(19) United States
(12) Patent Application Publication
(10) Pub. No.: US 2019/0200790 A1
(43) Pub. Date: Jul. 4, 2019

(54) APPARATUS FOR SHADING AND COOLING ARTICLES

(71) Applicants: Ben Terry Rudd, Pensacola Beach, FL (US); John Allen Cathey, Hollywood, FL (US)

(72) Inventors: Ben Terry Rudd, Pensacola Beach, FL (US); John Allen Cathey, Hollywood, FL (US)

(21) Appl. No.: 15/857,360

(22) Filed: Dec. 28, 2017

(51) Int. Cl. A47G 23/00; H02S 20/00

(52) U.S. Cl. CPC A47G 23/00; H02S 20/00

(57) ABSTRACT

An apparatus for cooling a beverage container with a planar base with a compartment formed within and a divider panel enclosing the compartment; a cooling element inserted into the compartment; and a canopy structure extending upwards from the planar base. The apparatus may have storage pockets connected to the canopy. The apparatus may have a solar panel for collecting solar energy attached to the outer surface of the canopy.

### RELATED APPLICATIONS

None.

### FIELD

The present invention relates to the field of table equipment. More specifically, the present invention relates to devices for shading and cooling a beverage container and otherwise protecting articles from the sun.

### BACKGROUND

Keeping beverages cold during the warmer months of spring, summer, and early fall is challenging. Drinks become warm under the glare of the hot sun when participating in outdoor activities, such as swimming or lounging poolside. Electromagnetic radiation from the surrounding environment and the sun's rays warms beverage containers and thus the drinks inside become warm. Further, there are several other articles that cannot withstand ambient heat such as electronic devices (phones, laptops, tablets, hand held gaming devices, etc.) as well as items that the user wants to keep cool such as keys, toys, and other personal items.

Heat is transferred through three mechanisms: conduction, convection, and radiation. Conducted heat occurs across a medium, such as a warm hand touching a beverage container. Convection of heat occurs between a surface and a moving fluid or gas when they are at different temperature. For the purposes of the proposed invention, the moving gas is the ambient air. Thermal radiation occurs when the sun emits electromagnetic waves that travel through space and transform into heat when they come in contact with an absorbing object. These electromagnetic waves can also be substantially reflected away by a reflective object.

There have been several attempts in the prior art to provide shade and or cooling to beverage containers when the ambient temperature rises. For example, a beverage cozy, also known as a “coozy,” is a cylindrical device designed to snugly fit around a standard aluminum beverage can. The device inhibits heat transfer by preventing convective heat transfer from a large percentage of the can's surface area. The cozy also inhibits conductive heat transfer by presenting a material with a low heat transfer coefficient adjacent to the highly conductive aluminum can. However, use of the coozy is limited generally to aluminum cans and specifically shaped containers and does little to reflect thermal radiation. It also does nothing to actively cool the container.

Additionally, there are various shading devices in the prior art but none that have the capability to shade a variety of items, including beverages, electronic devices, keys, toys, etc. Nor do they have the ability to actively cool the items with the device.

### BRIEF SUMMARY OF THE INVENTION

It is the object of the present invention to address several challenges in previous attempts to provide a device for the shading and cooling of articles to combat conducted, convected and radiated heat sources.

In a first embodiment of the present invention, an apparatus for shading and cooling an article container is disclosed. The apparatus generally has a planar base with a compartment formed within and a divider panel enclosing the compartment wherein a cooling element is inserted into the compartment. A canopy structure extends upwards from the planar base.

In a second embodiment, an apparatus for shading an article is disclosed. The apparatus has a planar base; legs for providing vertical structure support fixedly mounted to the planar base; and two arms for providing horizontal structure support fit together to support a sheet of material for shading the article.

In a third embodiment, an apparatus for cooling an article is disclosed with a planar base and a compartment formed within the base with a divider panel enclosing the compartment. A cooling element is inserted into the compartment. Legs for providing vertical structure support fixedly mount to the planar base; and two arms for providing horizontal structure support fit together to support a sheet of material for shading the article.

### BRIEF DESCRIPTION OF THE DRAWINGS

FIG. 1 is perspective front view of the present invention with the planar base compartment in the closed position.

FIG. 2 is perspective front view of the present invention with the planar base compartment in the open position.

FIG. 3 is an exploded perspective front view of the present invention with the planar base compartment in the open position.

FIG. 4A is a cutaway perspective front view of the present invention with the planar base compartment in the closed position.

FIG. 4B is a cutaway perspective front view of the present invention with the planar base compartment in the open position.

FIG. 5 is an exploded perspective front view of the present invention.

FIG. 6 1 is perspective front view of the present invention with the planar base compartment in the closed position.

FIG. 7 is perspective front view of an alternative embodiment of the present invention with the planar base compartment in the closed position.

### DETAILED DESCRIPTION

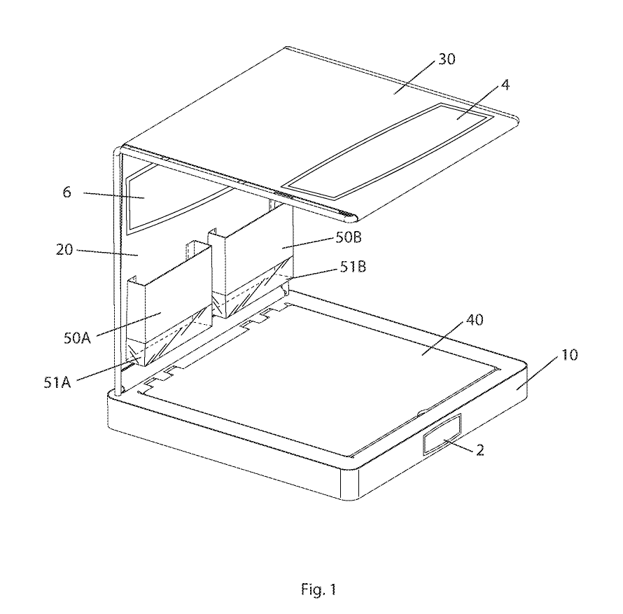

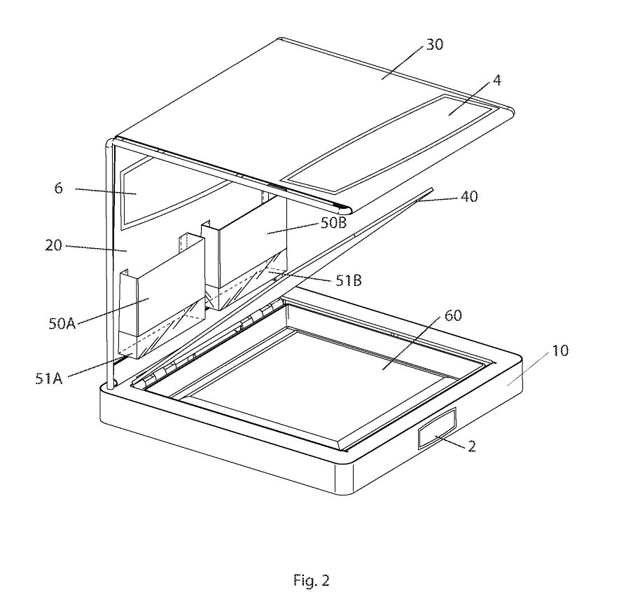

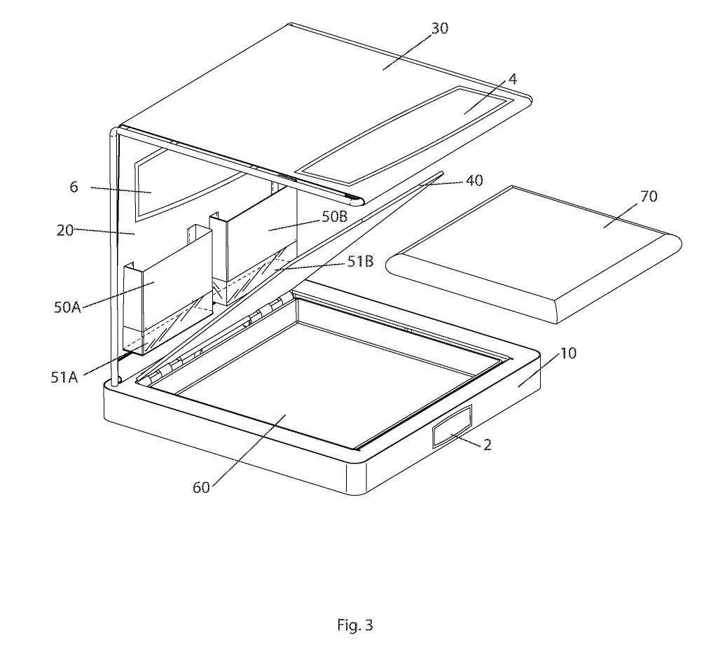

Turning to FIGS. 1-3, a planar base 10 has a storage compartment 60 formed within and a divider panel 40 enclosing the compartment wherein a cooling element 70 is inserted into the storage compartment. A canopy structure made from sheet 20 that extends upwards from the planar base 10 and sheet 30 that extends outwardly from sheet 20 and substantially parallel to the planar base 10 to provide shade. The planar base 10 may have a dedicated area 2 for adding a message, logo or other personalized item. The canopy 30 may have dedicated areas 4 and 6 for adding a message, logo or other personalized item. Additionally, sheets 20 and 30 may have pockets like 50A and 50B for storing personal items. The pockets 50A and 50B may have a window of clear or translucent material 51A and 51B, respectively, so that the items inside the pockets can be easily identified. The sheets 20 and 30 may be separate sheets or they may be connected. The sheets 20 and 30 may be constructed from a reflective material, a water-resistant material and/or a water proof material.

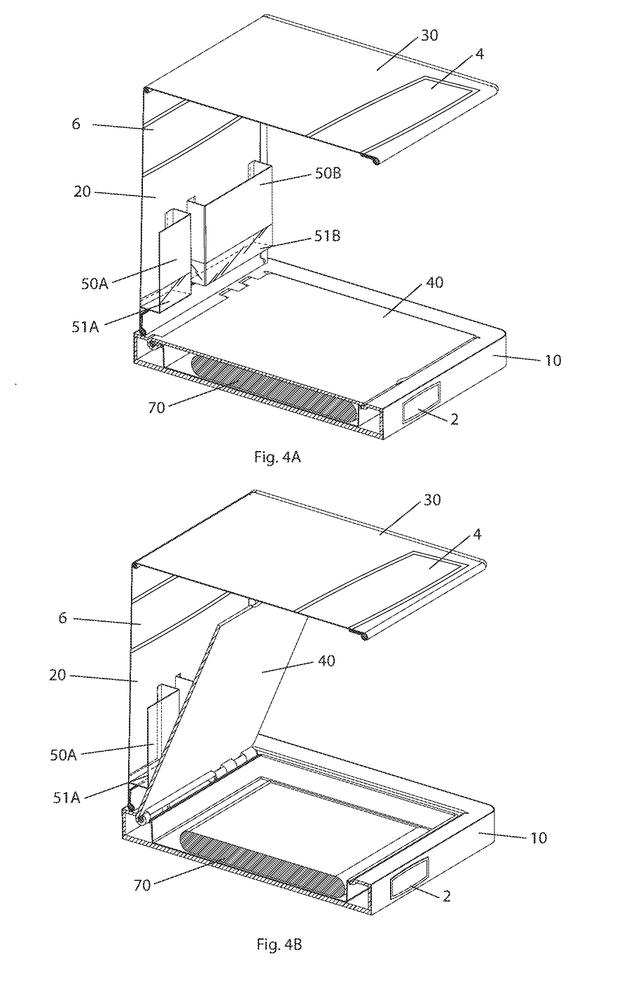

As shown in FIGS. 4A-B, the divider panel 40 may be connected to the planar base 10 using a hinged connection or any other connection that allows the divider panel 40 to be lifted upwards so that items may be placed in the compartment 60 created therein. In the preferred embodiment, an ice pack 70 is inserted.

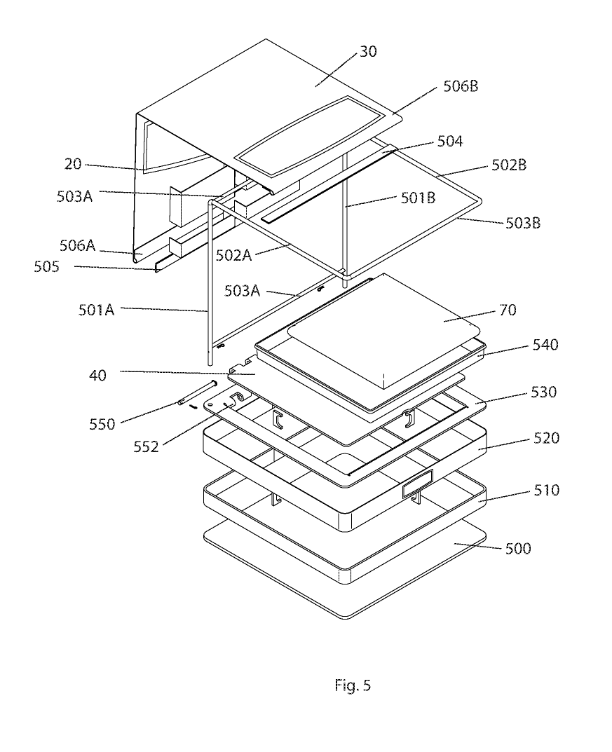

Turning to FIG. 5, an exemplarly embodiment of the present invention is shown. The canopy is generally formed from stretching a single sheet of material over a frame, the frame being formed by two legs 501A and 501B for providing vertical structure support fixedly mounted at a bottom end of each of the legs 501A and 501B to the planar base 10; two arms 502A and 502B for providing horizontal structure support; a first connector 503A between the legs 501A and 501B near the bottom end of each of the legs 501A and 501B; a second connector 503B between a distal end of the arms 502A and 502B; and a sheet of material formed by ends 20 and 30. The top end of a corresponding one of the legs 501A and 501B is fixedly mounted to a proximal end of a corresponding one the arms 502A and 502B. The sheet of material formed by 20 and 30 is mounted at a bottom end to the first connector 503A and mounted at the top end to the second connector 503B with an inner surface facing towards the base and an outer surface facing away from the base. The bottom of the sheet of material 20 is turned back on itself to form a bottom elongated sleeve 506A. The top of the sheet of material 30 is turned back on itself to form a top elongated sleeve 506B. The first connector 503A is inserted through the bottom elongated sleeve 506A and the second connector 503B is inserted through the top elongated sleeve 506B.

The planar base 10 with interior compartment may be formed in a variety of ways, but FIG. 5 sets forth an exemplary embodiment wherein a storage pan 540 rests inside the base 10 with the optional ice pack 70 sitting inside the pan 540. The divider panel 40 forms a lid and a substantially planar plate 500 forms a bottom to the planar base 10. The divider panel 40 is connected to the planar base 10 using a hinge wherein pin 550 inserts into hinge 552. The divider panel rests on top of hinged plate 530 when in the closed position. Hinged plate 530 rests on top of removable fabric layer 520 which rests telescopically over base plate 510. Base plate 510 is fixedly attached to planar plate 500.

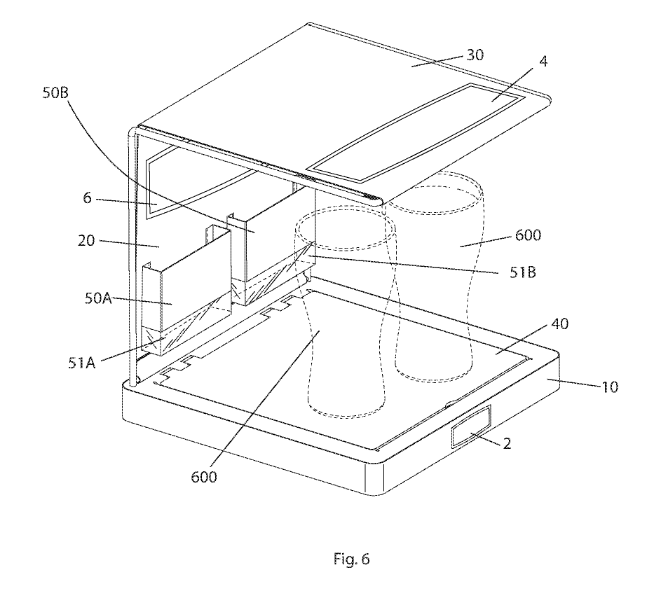

Turning to FIG. 6, when in use the invention serves to reflect radiated heat from hitting articles, such as beverage containers 600 or any articles stored under divider lid 40 or in pouches 50A and 50B, using sheets 20 and 30. Additionally, convected heat from the ambient air breeze heated by the sun that would heat the articles, such as beverage containers 600 or any articles stored under divider lid 40 or in pouches 50A and 50B, is shielded by sheets 20 and 30. Finally, the articles sitting on top of the divider panel 40 (which may be thermally insulated) may be cooled using conduction from the ice pack 70 (not shown in FIG. 6) stored under the divider panel 40.

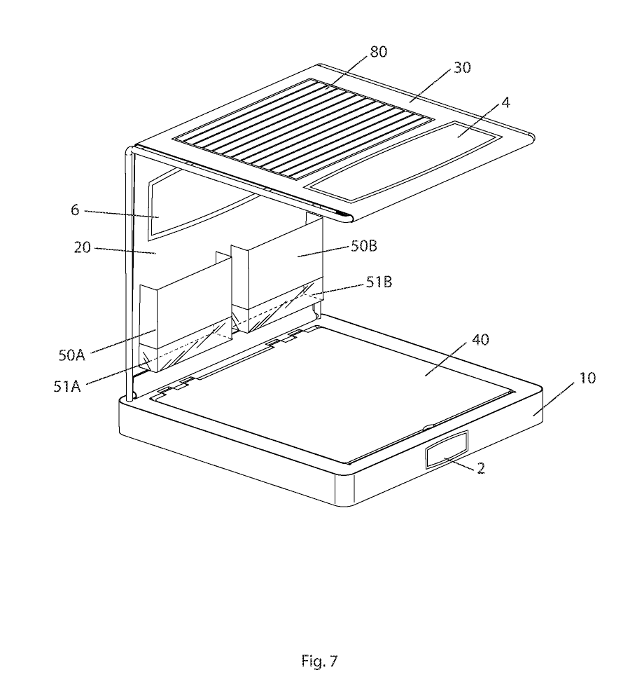

Finally, turning to FIG. 7, the device may be fitted with various upgrades, including a solar panel 80 that may be used to charge electronic devices while keeping them cool and free from damage due to overheating.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. An apparatus for shading an article, the apparatus comprising:
a planar base;
at least two legs for providing vertical structure support fixedly mounted at a bottom end of each of said legs to the planar base;
at least two arms for providing horizontal structure support;
a first connector between the legs near the bottom end of each of said legs;
a second connector between a distal end of the arms; and
a sheet of material;
wherein a top end of a corresponding one of said legs is fixedly mounted to a proximal end of a corresponding one of said arms; and
wherein the sheet of material is mounted at a bottom end to the first connector and mounted at the top end to the second connector with an inner surface facing towards the base and an outer surface facing away from the base.

2. The apparatus of claim 2 wherein the bottom of said sheet of material is turned back on itself to form a bottom elongated sleeve and wherein the top of said sheet of material is turned back on itself to form a top elongated sleeve and wherein the first connector is inserted through the bottom elongated sleeve and wherein the second connector is inserted through the top elongate sleeve.

3. The apparatus of claim 1 wherein the planar base has a storage compartment formed within.

4. The apparatus of claim 1 wherein the outer surface of the sheet of material is comprised of a material that reflects the sun.

5. The apparatus of claim 1 wherein at least one of the outer and the inner surface of the sheet of material are comprised of a material that is water resistant.

6. The apparatus of claim 1 wherein at least one of the outer and the inner surface of the sheet of material are comprised of a material that is water proof.

7. The apparatus of claim 1 further comprising a plurality of storage pockets connected to at least one of the inner surface and the outer surface of the sheet of material.

8. The apparatus of claim 1 further comprising a solar panel for collecting solar energy attached to the outer surface of the sheet of material.

9. An apparatus for cooling an article comprising;
a planar base with a compartment formed within and a divider panel enclosing the compartment;
a cooling element inserted into the compartment;
at least two legs for providing vertical structure support fixedly mounted at a bottom end of each of said legs to the base;
at least two arms for providing horizontal structure support;
a first connector between the legs near the bottom end of each of said legs;
a second connector between a distal end of the arms; and
a sheet of material;
wherein a top end of a corresponding one of said legs is fixedly mounted to a proximal end of a corresponding one of said arms; and
wherein the sheet of material is mounted at a bottom end to the first connector and mounted at the top end to the second connector.

10. The apparatus of claim 9 further comprising a hinge connecting the base to the divider panel and providing selective access to the compartment by lifting the divider panel.

11. The apparatus of claim 10 wherein the divider panel is thermally-insulating.

12. The apparatus of claim 9 wherein the bottom of said sheet of material is turned back on itself to form a bottom elongated sleeve and wherein the top of said sheet of material is turned back on itself to form a top elongated sleeve and wherein the first connector is inserted through the bottom elongated sleeve and wherein the second connector is inserted through the top elongate sleeve.

13. The apparatus of claim 9 wherein the outer surface of the sheet of material is comprised of a material that reflects the sun.

14. The apparatus of claim 9 wherein at least one of the outer and the inner surface of the sheet of material are comprised of a material that is water resistant.

15. The apparatus of claim 9 wherein at least one of the outer and the inner surface of the sheet of material are comprised of a material that is water proof.

16. The apparatus of claim 9 further comprising a plurality of storage pockets connected to at least one of the inner surface and the outer surface of the sheet of material.

17. The apparatus of claim 9 further comprising a solar panel for collecting solar energy attached to the outer surface of the sheet of material.

18. An apparatus for shading and cooling an article container comprising;
a planar base with a compartment formed within and a divider panel enclosing the compartment;
a cooling element inserted into the compartment; and
a canopy structure extending upwards from the planar base.

19. The apparatus of claim 18 further comprising a plurality of storage pockets connected to at least one of an inner surface and an outer surface of the canopy.

20. The apparatus of claim 18 further comprising a solar panel for collecting solar energy attached to the outer surface of the canopy.
